(19) United States
(12) Patent Application Publication
(10) Pub. No.: US 2014/0068852 A1
(43) Pub. Date: Mar. 13, 2014

(54) Bath in bed tub

(71) Applicant: May Ann Page, Orlando, FL (US)

(72) Inventor: May Ann Page, Orlando, FL (US)

(21) Appl. No.: 13/573,272

(22) Filed: Sep. 7, 2012

(51) Int. Cl. A61G 7/00

(52) U.S. Cl. CPC A61G 7/0005
USPC 4/547

(57) ABSTRACT

A Bed In Bath Tub bathing equipment for handicapped, ill, elderly, bedridden and other individuals (hereinafter collectively referred to as patient) to receive a tub bath while confined to or laying in a bed. The equipment is placed under the patient in the same manner as changing bedding for these types of patients by rolling the equipment under the patient while they remain in the bed and inflating the equipment around the patient. The invention is safe, cost effective, addresses a critical medical healthcare need, and eliminates the need for equipment that impacts the patient health care area, requires assembly, moves the patient from the bed, or the need for additional staff assistance to provide a full bath for the patient.

### BACKGROUND OF INVENTION

1. Field of Invention

This invention relates to handicapped, ill, elderly, bedridden and other individuals (hereinafter collectively referred to as patient). These patients cannot receive a complete and full bath without being moved from the bed, without assistance from two or more individuals, lifting equipment or due to their health and physical needs. As such, they are most commonly cleaned with a “Towel Bath”, using a wash cloth to wipe and clean body parts. The towel bath type of bathing and body cleaning does not provide the same benefits of having the body of the patient completely or partially immersed in water as with a regular bath. In the case of home health care, when the patient is generally cared for by one person, very often the assistance of a second person or lifting equipment is unavailable and the patient may go for long and extended periods without receiving a complete bath.

Patients confined to a bed have different healthcare and cleaning requirements than a healthy person. Patients confined to beds have more body secretions, dust, dead skin and fluids which are not fully removed with a towel bath. These factors contribute to body odors, sores and adhesions that cannot be prevented with a towel bath. Further, in addition to the physical and medical health benefits from receiving a complete bath, patients receive an increased mental benefit that adds to healing and recovery as a result of the bath and being completely clean.

2. Description of Related Art

Research on bath tub equipment, products or other apparatus used for the patients identified in the field of invention; has determined the majority of other equipment and products developed for these type of patients have several restrictions and limitations to include: moving the patient from the bed in one manner or the other using a lifting device, wheelchair or staff; decreased space in the patient healthcare area as a result of placing and managing equipment; using more than one person to assist the patient in receiving a bath; assembly of equipment; and cost of equipment. Cost factors are particularly important for patients receiving home healthcare, with limited medical coverage or are cared for by others including family members and receive no medical assistance. Bathing equipment and devices developed for these patients to date recognize the importance of providing the patient a complete bath that allows for complete or partial submersion in water. Secondly, the inventions recognize the critical importance of safety when moving patients.

The Bath In Bed Tub eliminates previously identified constraints and limitations and provides patients a healthy and necessary device that is safe, effective and cost considerate. The Bath In Bed Tub can be completely administered by one person, without moving the patient from the bed. The Bath In Bed Tub, unlike other inventions, is administered and operated in the same manner used by health care workers to change patient bedding when the patient is confined to the bed as identified in the application abstract.

### SUMMARY OF INVENTION

The Bath In Bed Tub invention allows patients (previously identified in the abstract and field of invention) confined to a bed to receive a complete bath without leaving the bed, the assistance of lifting equipment, product assembly, a second staff person to help lift and manage the patient, and does not limit the patient healthcare and living area. The invention greatly improves the healthcare of the patient through increased ability to effectively clean the patient, prevent common health problems of patients confined to a bed to include bed sores, abrasions, reduces pain and discomfort, is safe and cost effective and provide patients the mental and physical benefits of bathing and being completely clean.

### DESCRIPTION OF DRAWINGS

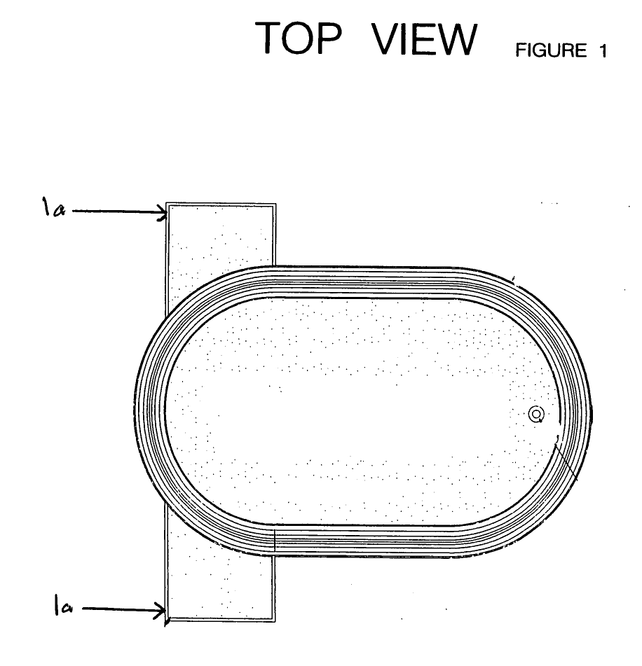

1.FIG. 1 Top View--Drawing details the top view of the Bath In Bed Tub and includes the tub basin, lifting flaps, sides, inflation and deflation access and tub drain.

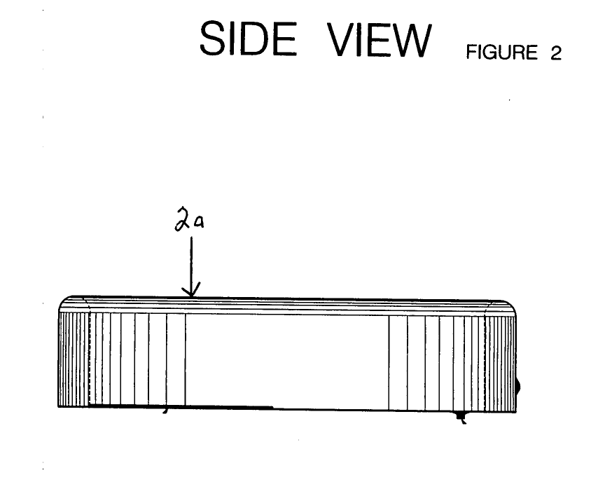

2.FIG. 2 Side View--Drawings details the side view of the Bath In Bed Tub.

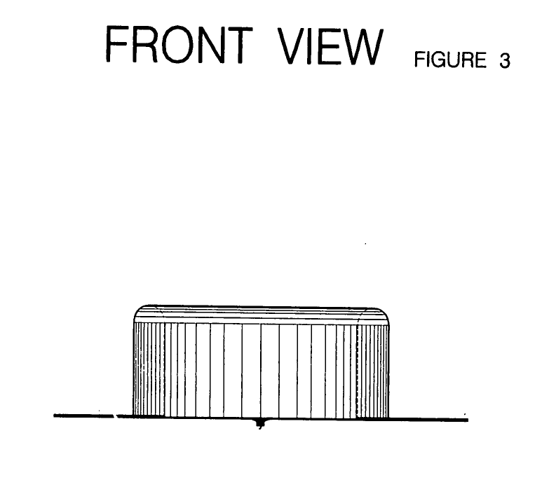

3. FIG. 3 Front View--Drawings details inflated front side, movement/lifting flaps and tub drain.

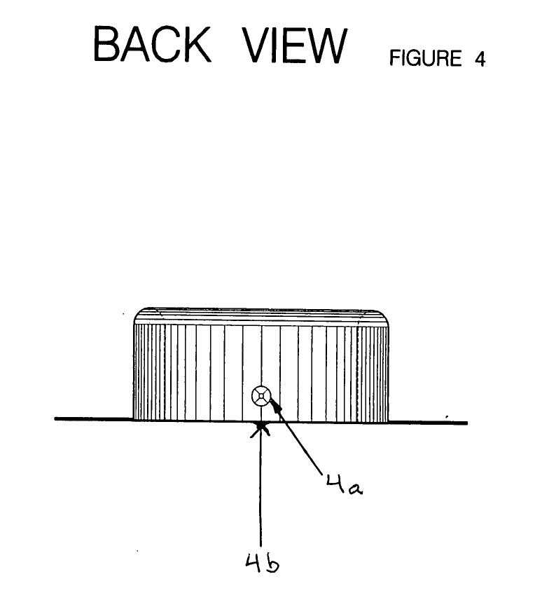

4. FIG. 4 Back View--Drawings detail inflated back side, tub drain and inflation and deflation access.

### DETAILED DESCRIPTION OF INVENTION BATH IN BED TUB

The Bath In Bed Tub has a flat non inflatable bottom (FIG. 1); only the sides including front and back of tub are inflatable. Movement/lifting flaps (1a) are detailed and are used to move bed in bath tub when placed under patient but prior to filling with bath water. The Bath In Bed Tub is placed under the patient using the standard healthcare process of changing bed linen for these patients by rolling the patient from one side of the bed to the other. The size dimensions of the Bath In Bed Tub are fourteen inches (14″) deep, four feet and ten inches (4′ 10″) long and two feet and five inches (2′ 5″)inches wide. (FIG. 2) Inflated walls (2a) are four inches wide (4″) and surround the patient and contain bath water. All inflation occurs at the single point of inflation (2b) and all areas are inflated at the same time using a standard electrical or non electrical pump.

Front of Bath In Bed Tub (FIG. 3) is inflated and patient head and back are placed in this area. (FIG. 4) Bath In Bed Tub inflation (4a), and drain (4b) are located at back and back bottom. The Bath In Bed Tub is filled with water manually once inflated by pouring in water or using a standard hose attachment. The hose attachment is connected to a standard water source, i.e. sink or tub faucet or reservoir. Water temperature is controlled by person giving the bath. Bath In Bed Tub drain (4b) is located at back bottom. Drain is covered with a standard drain cap for an ⅜″ hose line. Water is drained by removing drain cover and using a standard hose or standard electrical or non electrical pump when bathing is completed. Bath In Bed Tub is deflated and drained prior to removing Bath In Bed Tub from under patient.

1. This patent application is a single claim for the “Bath in Bed Tub” invention as detailed in this application. Replacement Drawings and Substitute Specifications/descriptions of the Bath in Bed Tub are included in this application where required.
